(19) United States
(12) Patent Application Publication
(10) Pub. No.: US 2007/0041598 A1
(43) Pub. Date: Feb. 22, 2007

(54) System for location-sensitive reproduction of audio signals

(76) Inventors: Guenther Pfeifer, Dresden (DE); Ruediger Hoffman, Dresden (DE); Wolfgang Niehoff, Wedemark (DE); Rolf Meyer, Wedemark (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/556,019

(22) PCT Filed: Mar. 29, 2004
(86) PCT No.: PCT/EP04/03297

§ 371 Date: Jun. 20, 2006

(30) Foreign Application Priority Data
May 7, 2003 (DE) 103 20 274.9

(51) Int. Cl. H04R 5/02

(52) U.S. Cl. 381/303

(57) ABSTRACT

The invention concerns a system for and a method of location-sensitive reproduction of audio signals. The object of the invention is therefore to provide a system for the reproduction of audio signals, which is capable of providing for optimum reproduction of audio signals at a plurality of points in space. In accordance with the invention, a system for location-sensitive reproduction of audio signals comprises at least one electroacoustic transducer for the reproduction of audio signals, at least one location-sensitive detection device for detecting the position of at least one object for which a reproduction of audio signals is intended, and a central unit for calculating and controlling the audio signal output of each individual transducer for the optimum reproduction of the audio signals at the position of the object, which is detected by the location-sensitive detection device.

### CROSS-REFERENCE TO RELATED APPLICATIONS

This application claims priority of International Application No. PCT/EP2004/003297, filed Mar. 29, 2004 and German Application No. 103 20 274.9, filed May 7, 2003, the complete disclosures of which are hereby incorporated by reference.

### BACKGROUND OF THE INVENTION

a) Field of the Invention

The invention concerns a system for and a method of location-sensitive reproduction of audio signals.

b) Description of the Related Art

In the area of electroacoustic signal recording or reproduction, there exist some tasks in regard to which there would be a wish to allocate an acoustic signal to a person or an audio source or to record it therefrom.

In acoustic signal recording, this is usually achieved either by mechanical tracking of a microphone or a directional microphone or by electrical tracking by means of a microphone array.

In this connection, as general state of the art, attention is directed to DE 40 27 338 A1, DE 43 07 490 A1, JP 01-276900A (Patent Abstracts of Japan), DE 195 40 795 C2, DE 100 35 222 A1, U.S. Pat. No. 6,005,610 A and WO 02/079792 A2.

The field of electroacoustic signal reproduction involves operation with a plurality of reproduction systems or loudspeakers. The simplest known case is stereo reproduction with two loudspeakers. Multi-channel systems such as, for example, the 5+1 systems involve using a corresponding number of reproduction systems or loudspeakers. All known reproduction systems, however, suffer from the common disadvantage that they permit high-quality reproduction only at a specific receiving point or in a close vicinity thereof. That receiving point is generally also referred to as the sweet point.

Extremely directional audio reproduction systems are known which by means of ultrasound are capable of permitting pinpoint reproduction of audio signals.

Particularly in the interaction with microprocessor-controlled uses, in the area of signal reproduction there is a wish to provide devices which permit optimum reproduction of the highest possible quality not just at one point. In addition, the aim is to make that possible for a number of persons in a room, who can be at different locations.

### OBJECT AND SUMMARY OF THE INVENTION

The primary object of the invention therefore is to provide a system for the reproduction of audio signals, which is capable of providing optimum reproduction of audio signals at a plurality of points in space.

In that respect, the invention is based on the idea of providing a system in which electroacoustic transducers are combined with location-sensitive sensors.

Accordingly, there is provided a system for location-sensitive reproduction of audio signals, wherein the system has at least one electroacoustic transducer, at least one location-sensitive detection device and a central unit. In this case, the electroacoustic transducers serve for reproduction of the audio signals and the location-sensitive detection devices serve for detection of the position of at least one object in a room, for which reproduction of audio signals is intended. In this arrangement, the central unit serves for calculation and control of audio signal output of each individual transducer for optimum reproduction of the audio signals to the position of the object, which is detected by the detection device.

As the position of an object is determined by means of the location-sensitive detection devices, reproduction of the audio signals can be adapted to that position in order to achieve reproduction which is as optimum as possible.

In accordance with a configuration of the invention, detection and control of the audio signal output of the electroacoustic transducers are effected in real time.

In accordance with a further configuration of the invention, a respective electroacoustic transducer and a location-sensitive detection device are provided in a common housing.

In accordance with a further configuration of the invention, the electroacoustic transducers are also suitable for recording audio signals. In that respect the central unit is further suitable for correlating the audio signals recorded by the electroacoustic transducer with the position information of the location-sensitive detection devices in order to select that electroacoustic transducer whose recorded audio signals are most suitable in regard to the recognition of audio signals.

Detection of the location- and transit time-related signals of the electroacoustic transducers by means of the location-sensitive detection devices permits a markedly faster selection of the most acoustically favorable transducer. Optimization of the audio signals is also possible.

### BRIEF DESCRIPTION OF THE DRAWINGS

The invention is described in detail hereinafter with reference to the drawings in which:

FIG. 1 shows a diagrammatic representation of a room with a reproduction system according to the invention, in a first embodiment; and

FIG. 2 shows a diagrammatic representation of a room with a reproduction system according to the invention, in a second embodiment.

### DESCRIPTION OF THE PREFERRED EMBODIMENTS

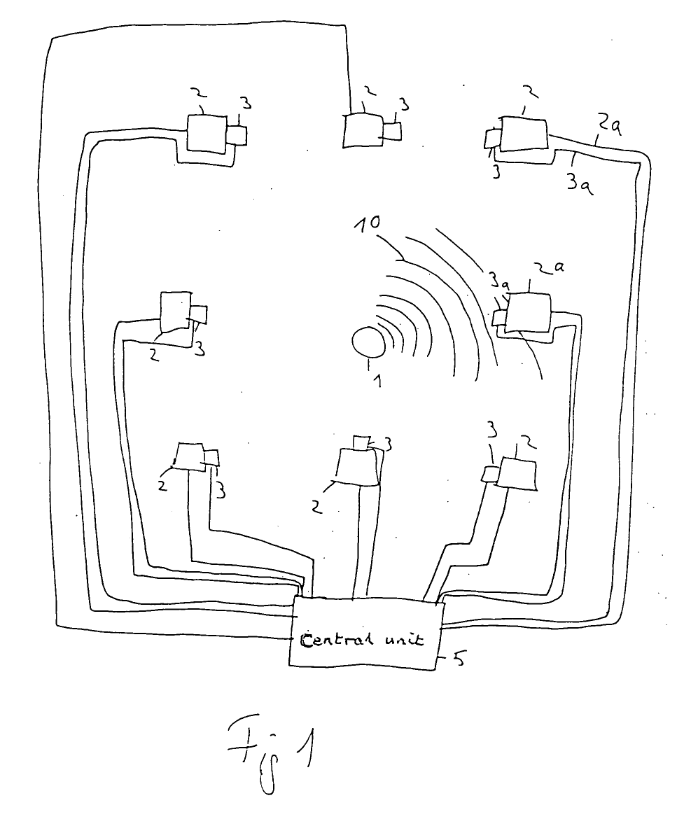

FIG. 1 shows a diagrammatic view of a room with a reproduction system according to the invention in a first embodiment of the invention. Disposed in the room is an object 1, a plurality of electroacoustic transducers 7 and location-sensitive detection devices 3 and a central unit 5. In that case, an audio signal is to be reproduced pinpoint at the position of the object 1. All electroacoustic transducers 7 and detection devices are connected to the central unit 5.

The detection devices 3 detect the position of the object 1 within the room. Those items of position information are then passed to the central unit 5. On the basis of those items of position information in respect of the object 1, the audio signal output of each of the electroacoustic transducers 7 is calculated in the central unit 5 in such a way that optimum reproduction of the audio signal at the position of the object 1 is made possible.

In this arrangement position, detection of the object 1 can be effected statically or dynamically so that the object 1 can move in the room and optimum reproduction of the audio signal is always made possible at the current position of the object.

Preferably an electroacoustic transducer 7 and a location-sensitive detection device are installed in a common housing. In order to ensure optimum coverage of a room, a plurality of those housings with an electroacoustic transducer and a location-sensitive detection device are provided distributed in the room. In such case, the location-sensitive detection devices 3 can have a computing unit for calculating the position of the object 1. As an alternative thereto, position calculation can be effected in the central unit 5.

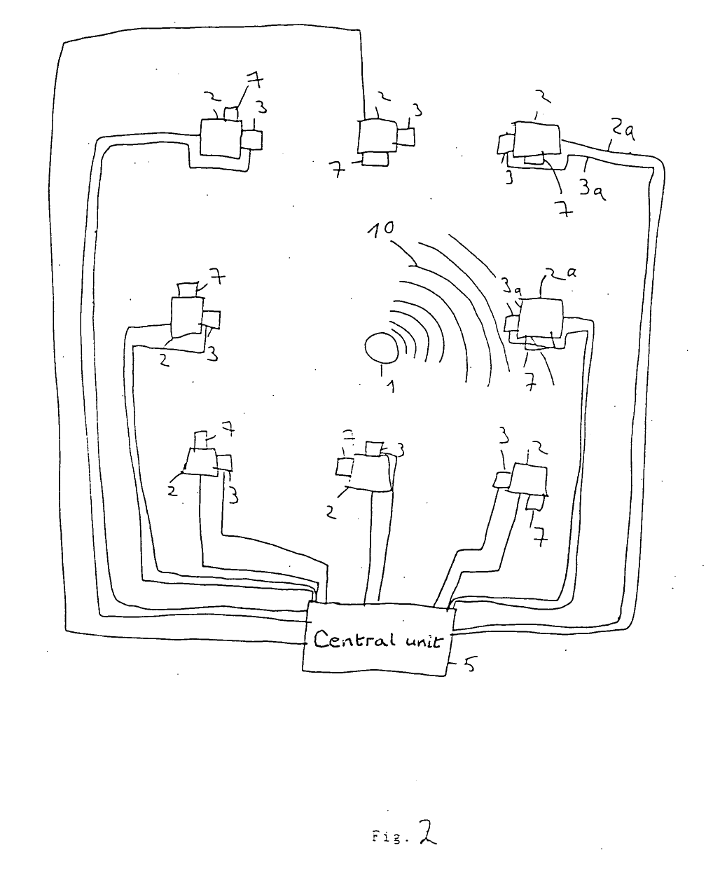

FIG. 2 is a diagrammatic illustration of a room with a reproduction system according to the invention in a second embodiment of the invention. In this respect the structure of the reproduction system substantially corresponds to that of the reproduction system in accordance with the first embodiment of the invention. In addition to the components shown in FIG. 1, the reproduction system according to the second embodiment has a plurality of microphones 2. Preferably the microphones are each disposed in a respective housing with the electroacoustic transducer 7 and the location-sensitive detection device 3. As an alternative thereto, the electroacoustic transducer 7 can be designed both for reproduction and also recording of audio signals.

In the example shown in FIG. 2, the audio signals of the audio source firstly impinge on the microphone 2a and the detection device 3a which are at the center on the right. In other words, therefore, it is to be expected that the audio signals recorded by that microphone involve the best signal/noise ratio, that is to say that microphone must be selected by the central unit as quickly as possible. For that purpose the central unit firstly evaluates all signals from the location-sensitive detection devices 3 in order to establish the position of the audio source 1 in the room. That procedure can be implemented both statically and also dynamically. By virtue of evaluation of the position of the audio source 1, the central unit 5 can predict which of the microphones 2 which are distributed in the room can probably provide the best signal, that is to say the signal with the best signal/noise ratio. Accordingly the acoustic signals recorded by the microphones and the signals coming from the location-sensitive detection devices 3 are correlated in the central unit 5.

The signals of the other microphones 2 can also be used for improving speech recognition insofar as, in dependence on the location of the respective microphone and the transit time of the audio signals 10, they are added to or subtracted from the signals of the selected microphone in order to form a support signal. Advance selection of the most favorable microphone makes it possible to maintain a required reaction time for speech recognition of 300 ms.

The connection between the central unit and the respective microphones 2 and the location-sensitive detection devices 3 can be either wireless or wired. In addition, the number of microphones does not have to correspond to the number of the location-sensitive detection devices 3, that is to say, it is also possible to provide fewer location-sensitive detection devices as long as it is guaranteed that the position of the speech source 1 can be sufficiently well detected.

Preferably the speech source 1 is represented by a user of a machine or an item of equipment, who would like to control the machine or the item of equipment by means of speech commands.

Reproduction of audio signals is effected in that case as described in the first embodiment.

In accordance with a third embodiment of the invention, in each case an electroacoustic transducer 7 and a location-sensitive detection device are disposed in a respective housing. Optionally it is also possible to provide a computing unit for calculating the position of an object 1 in the common housing. In this case, the housing has connections, by means of which both the electroacoustic transducer and also the location-sensitive detection device can be coupled to a central unit 5. The coupling can be both wired and wireless.

The above-described housings can be implemented in the form of standardized housings in installation technology, such as, for example, switches, pushbutton switches, plug connections or the like. As an alternative thereto, they can be provided jointly with the pushbutton switches, switches, plug connections, tapping boxes, junction boxes or the like in the standard housings of installation technology. In addition to the above-described arrangements, devices for signal boosting and signal processing can also be provided in the housing. Those signal boosting and signal processing devices can be designed, for example, for the implementation of a speech recognition device or command defining.

In addition, the arrangement may have a transmitting and receiving device for transmitting and/or receiving signals, that is to say, for communication with a central unit 5. In such case, the transmitting/receiving device can be connected to a network inside the house such as, for example, a home bus, an install bus, a power line or the like. As an alternative thereto, the transmitting/receiving device can be designed for wireless communication. That wireless communication can be effected, for example, on the basis of WLAN, Bluetooth, long wave, induction or the like.

Besides electromagnetic signals, for the position-determining operation, it is also possible to use infrared, ultrasound thermal radiation and the like. As an alternative thereto, TV cameras and sensors can also be used as spacing room and motion sensors and can be integrated, for example, into the above-mentioned installation housings.

All electroacoustic transducers and location-sensitive detection devices disposed in the installation housings can either be supplied directly from the voltage network or by way of an internal battery supply.

In accordance with a fourth embodiment, the electroacoustic transducer and the location-sensitive detection device is implemented on the basis of ultrasound technology in a common component. In this case, the electroacoustic transducer can be in the form of a capacitive transducer or a sell transducer. Preferably a frequency range outside the audible range is selected for the location-sensitive detection device. For the speech range, however, the frequency range necessary for reliable speech recognition is selected. Accordingly, operation can be effected both in the parallel mode, that is to say, ultrasound and audible sound, and in the timeshearing mode. In the timeshearing mode the transducer emits short or extremely short pulses for detecting position. Thereupon the transducer is switched as a recording transducer and receives both the items of position information from the emitted pulse and also the speech signal. In the case of sell transducers, a structured diaphragm with a common counterpart electrode can be used.

As an alternative thereto, the electroacoustic transducer and the location-sensitive detection device can be embodied in a common, micromechanically produced transducer.

Signal processing can be effected either decentrally, that is to say, separately in each housing, or centrally in a central unit. In central implementation of signal processing, the items of information from the respective location-sensitive detection devices can be processed in the central unit in order to select the optimum microphone position upon signal recording from a plurality of units and to ensure an optimum reproduction point or an optimum reproduction space element in signal reproduction jointly with the other units.

The system according to the invention or the acoustic device can also be adapted to acoustically record command signals and convert them into corresponding machine commands. For that purpose it is particularly advantageous if given machine commands are associated in a database with corresponding terms so that, in a desired situation, for example for adjusting the entire system or individual parameters, for example frequency response characteristic, sensitivity, switching-on and switching-off function, etc are adjusted. Such speech control under some circumstances facilitates adjustment of the entire system and is therefore particularly advantageous.

While the foregoing description and drawings represent the present invention, it will be obvious to those skilled in the art that various changes may be made therein without departing from the true spirit and scope of the present invention.

1-7. (canceled)

8. A system for location-sensitive recording/reproduction of audio signals comprising:
a plurality of electroacoustic transducers for the reproduction of first audio signals;
a plurality of microphones for recording second audio signals;
at least one location-sensitive detection device for detecting the position of at least one object; and
a central unit for calculating and controlling the audio signal output of each individual electroacoustic transducer for the optimum reproduction of the first audio signals at the position of the object, which is detected by the location-sensitive detection device, and for correlating the second audio signals recorded by the microphones and the items of position information from the location-sensitive detection devices in order to select that second audio signal recorded by one of the microphones, which is best suited for recognition of the audio signals,
wherein in each case of use an electroacoustic transducer, a microphone and a location-sensitive detection device are arranged in a housing.

9. The system as set forth in claim 8, wherein the central unit is adapted to effect detection and control in real time.

10. The system as set forth in claim 8, wherein the central unit selects that second audio signal recorded by a microphone, which has the greatest signal/noise ratio.

11. The system as set forth in claim 8, wherein
the housings each with an electroacoustic transducer, a microphone and a location-sensitive detection device are arranged spatially distributed.

12. The system as set forth in claim 8, further comprises a signal addition device for adding or subtracting the second audio signals recorded by the other microphones in dependence on the position of the respective microphones and the transit times of the second audio signals recorded by the respective microphones.
